(19) United States
(12) Patent Application Publication
(10) Pub. No.: US 2025/0021168 A1
(43) Pub. Date: Jan. 16, 2025

(54) METHOD AND DEVICE FOR INTERPRETING USER GESTURES IN MULTI-REALITY SCENARIOS

(71) Applicant: SAMSUNG ELECTRONICS CO., LTD., Suwon-si (KR)

(72) Inventor: Ravi SHARMA, Noida (IN)

(73) Assignee: SAMSUNG ELECTRONICS CO., LTD., Suwon-si (KR)

(21) Appl. No.: 18/657,297

(22) Filed: May 7, 2024

Related U.S. Application Data
(63) Continuation of application No. PCT/KR2024/004673, filed on Apr. 8, 2024.

(30) Foreign Application Priority Data
Jul. 12, 2023 (IN) 202311046752

(51) Int. Cl. G06F 3/01; G06T 7/70; G06T 7/80; G06V 10/26; G06V 10/764; G06V 20/20; G06V 20/50; G06V 40/20

(52) U.S. Cl. CPC G06F 3/017; G06T 7/70; G06T 7/80; G06V 10/273; G06V 10/764; G06V 20/20; G06V 20/50; G06V 40/28; G06T 2207/30196; G06T 2207/30244

(57) ABSTRACT

Disclosed is a method, implemented in a Visual See Through (VST) device, for interpreting user gestures in multi-reality scenarios. The method includes identifying one or more camera view zones based on fields of view of one or more cameras, determining one or more contexts based on an analysis of each of the one or more camera view zones, classifying the one or more camera view zones for each of the determined one or more contexts, and recognizing a user gesture as an input based on the classified one or more camera view zones.

### CROSS-REFERENCE TO RELATED APPLICATIONS

This application is a bypass continuation application of International Application No. PCT/KR2024/004673, filed on Apr. 8, 2024, which is based on and claims priority to Indian patent application No. 202311046752, filed on Jul. 12, 2023, the disclosures of which are incorporated by reference herein in their entireties.

### BACKGROUND

### 1. Field

The disclosure relates to the field of wearable devices, and more particularly to a Visual See Through (VST) device and method for adaptive interpretation of user gestures in multi-reality scenarios.

### 2. Description of Related Art

Visual see-through devices, also known as smart glasses, are wearable devices that combine virtual reality (VR) content and augmented reality (AR) content with a real-world environment. These devices enable users to see and interact with the VR content and the AR content overlaid onto user's physical surroundings of the users, providing a mixed-reality experience.

Visual see-through devices consist of a transparent display system, sensors, cameras, and a processing unit. The transparent display system overlays virtual content onto user's field of view thereby enabling users to interact with virtual objects while maintaining awareness of the user's physical surroundings.

The visual see-through devices also utilize gesture control to enable interactions with the virtual content. The gesture control in the related art visual see-through devices allows users to interact with the virtual content and manipulate digital objects using hand and body movements. While the gesture control in the related art visual see-through devices offers multiple benefits, some associated challenges need to be addressed.

The visual see-through devices have certain limitations in terms of accuracy and robust gesture recognition. When a gesture is performed by a user, the performed gesture can be identified by the visual see-through devices. However, in case of multiple views or multiple possible recipients of the gesture, the existing visual see-through devices fail to determine if the gesture is meant for the real-world, VR scene, or AR objects shown to the user.

Therefore, there is a need for an improved method and device that can overcome all the above-discussed limitations and problems of the existing visual see-through devices.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

According to an aspect of the disclosure, there is provided method, implemented in a Visual See Through (VST) device. The method may include identifying one or more camera view zones based on fields of view (FOVs) of one or more cameras. The method may include determining one or more contexts based on an analysis of each of the one or more camera view zones. The method may include classifying the one or more camera view zones for each of the determined one or more contexts. The method may include recognizing a user gesture as an input based on the classified one or more camera view zones.

According to an aspect of the disclosure, there is provided a Visual See Through (VST) device for interpreting user gestures in multi-reality scenarios. The VST device may include one or more cameras. The VST device may include memory configured to store instructions. The VST device may include one or more processors, wherein the instructions, when executed by the one or more processors, cause the VST device to identify one or more camera view zones based on Field of views (FOVs) of one or more cameras. The VST device may include one or more processors, wherein the instructions, when executed by the one or more processors, cause the VST device to determine one or more contexts based on an analysis of each of the one or more camera view zones. The VST device may include one or more processors, wherein the instructions, when executed by the one or more processors, cause the VST device to classify the one or more camera view zones for each of the determined one or more contexts. The VST device may include one or more processors, wherein the instructions, when executed by the one or more processors, cause the VST device to recognize a user gesture as an input based on the classified one or more camera view zones.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and/or other features and aspects of the disclosure will become better understood when the following detailed description is read with reference to the accompanying drawings in which like characters represent like parts throughout the drawings, wherein:

FIG. 1 illustrates a block diagram of a Visual See Through (VST) device for interpreting user gestures in multi-reality scenarios, according to an embodiment;

FIG. 2 illustrates an example of a multi reality view through a glass frame of the VST device, according to an embodiment;

FIG. 3 illustrates an example diagram depicting a coverage map generated by a camera field of view analysis module of the VST device, according to an embodiment;

FIG. 4 illustrates an example of defining one or more camera view zones in the coverage map by a camera view zone identification Module of the VST device, according to an embodiment;

FIG. 5 illustrates an example of analyzing a user gesture by a gesture analysis module of the VST device, according to an embodiment;

FIG. 6 illustrates an example of identifying one or more targets corresponding to the user gesture by a target identification module of the VST device, according to an embodiment;

FIG. 7 illustrates an example of classifying the one or more camera view zones by a zone classification module of the VST device, according to an embodiment;

FIG. 8 illustrates an example of allocating input acceptance boundary by an input acceptance boundary cue engine of the VST device, according to an embodiment;

FIG. 9 illustrates an example of displaying an input boundary cue for the input acceptance boundary by an interaction engine of the VST device, according to an embodiment;

FIG. 10 illustrates a flow chart of a method for interpreting the user gestures in the multi-reality scenarios, according to an embodiment;

FIG. 11 illustrates a detailed flow chart of the method for interpreting the user gestures in the multi-reality scenarios, according to an embodiment; and

FIG. 12 illustrates an example hardware configuration of the VST device, according to an embodiment.

FIG. 13 illustrates a scenario of interpreting the user gestures in the multi-reality scenarios, according to an embodiment.

FIGS. 14A-14B illustrate a scenario when the user gesture is used to select the object from one or more objects, according to an embodiment.

Further, skilled artisans will appreciate that those elements in the drawings are illustrated for simplicity and may not have necessarily been drawn to scale. For example, the flow charts illustrate the method in terms of steps involved to help to improve understanding of aspects of the disclosure. Furthermore, in terms of the construction of the device, one or more components of the device may have been represented in the drawings by conventional symbols, and the drawings may show only those details useful to understanding the one or more embodiments of the disclosure so as not to obscure the drawings with details that will be readily apparent to those of ordinary skill in the art having the benefit of the description herein.

### DETAILED DESCRIPTION

Reference will now be made to an embodiment illustrated in the drawings and specific language will be used to describe the same. It should be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory and are not intended to be restrictive thereof.

Reference throughout this disclosure to “an aspect”, “another aspect” or similar language means that a particular feature, structure, or characteristic described in connection with an embodiment is included in at least one embodiment of the present disclosure. Thus, appearances of the phrase “in an embodiment”, “in one or more embodiments”, “in another embodiment”, and similar language throughout this disclosure may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

In the present disclosure, an expression “A or B,” “at least one of A and/or B,” “one or more of A and/or B,” or the like, may include all possible combinations of items enumerated together. For example, “A or B,” “at least one of A and B,” or “at least one of A or B” may indicate all of 1) a case in which at least one A is included, 2) a case in which at least one B is included, or 3) a case in which both of at least one A and at least one B are included.

An embodiment herein and the various features and aspects thereof are explained more fully with reference to the non-limiting embodiments that are illustrated in the accompanying drawings and detailed in the following description. Descriptions of well-known components and processing techniques are omitted so as to not unnecessarily obscure an embodiment herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended to facilitate an understanding of ways in which an embodiment herein can be practiced and to further enable those skilled in the art to practice an embodiment herein. Accordingly, the examples should not be construed as limiting the scope of an embodiment herein.

An embodiment may be described and illustrated in terms of modules or engines that carry out a described function or functions. These modules or engines, which may be referred to herein as units or blocks or the like, or may include blocks or units, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of an embodiment may be physically separated into two or more interacting and discrete blocks without departing from the scope of the disclosure. Likewise, the blocks of an embodiment may be physically combined into more complex blocks without departing from the scope of the disclosure.

The accompanying drawings are provided to help easily understand various technical features and it should be understood that an embodiment presented herein are not limited by the accompanying drawings. As such, the disclosure should be construed to extend to any alterations, equivalents, and substitutes in addition to those which are set out in the accompanying drawings. Although the terms first, second, etc., may be used herein to describe various elements, these elements should not be limited by these terms. These terms are generally only used to distinguish one element from another.

An embodiment will be described below in detail with reference to the accompanying drawings.

In an embodiment, a Visual See Through (VST) device for interpreting a user gesture in a multi-reality scenario is disclosed. The VST device includes one or more cameras and one or more sensors to sense a surrounding field of view of a user of the VST device and capture a user gesture. The VST device has two display screens one on a left-hand side and the other on a right-hand side. Both the display screens are configured to display virtual reality (VR) content and augmented reality (AR) content, mixed reality (MR) content, extended reality (XR) content or present a real-world view to the user of the VST device. When the user gesture is identified or detected, the VST device determines if the user gesture is for the real-world, VR scene, or AR objects being displayed on the display screens. The VST device accurately interprets and responds to the user gesture by dividing the surrounding field of view into distinct one or more camera view zones. For each camera view zone, the VST device may also perform contextual analysis to determine one or more potential targets for the user gesture and the intended meaning of the user gesture for each of the potential targets. Further, the gesture may be evaluated as either accepted or rejected for different potential targets based on an overall correlated context.

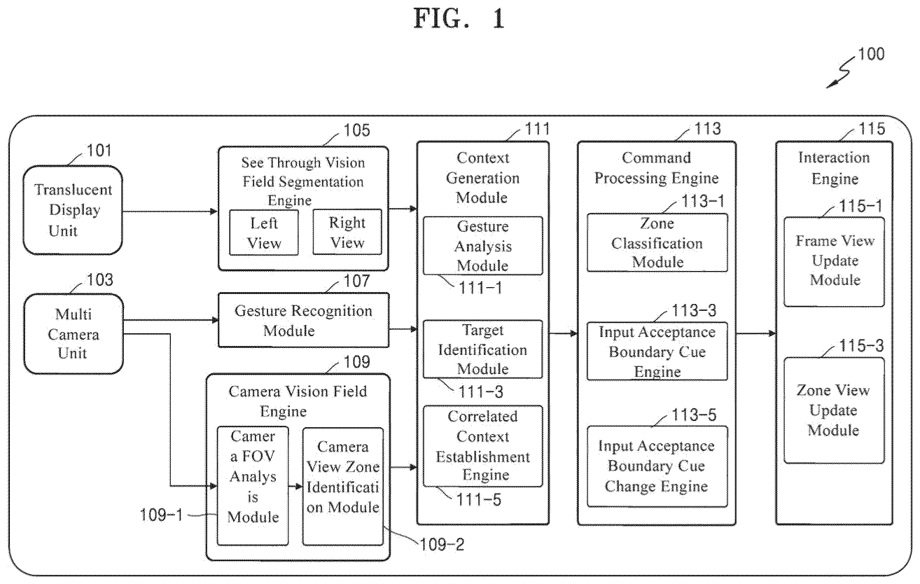

FIG. 1 illustrates a block diagram of a Visual See Through (VST) device 100 for interpreting user gestures in multi-reality scenarios, according to an embodiment disclosed herein. The VST device 100 may include a translucent display unit 101, a multi camera unit 103, a see through vision field segmentation engine 105, a gesture recognition module 107, a camera vision field engine 109, a context generation module 111, a command processing engine 113, an interaction engine 115.

The translucent display unit 101 may include a glass frame. The glass frame may include a left frame and a right frame. Each of the left frame and the right frame may be used to display the VR or AR content or present the real-world view to the user associated with the VST device 100. The translucent display unit 101 may overlay the VR content or the AR content onto the real-world view of the user. The overlaying of the VR content or the AR content onto the real-world view may enable the user to interact with virtual objects while maintaining awareness of the real-world view.

The multi camera unit 103 may include one or more cameras to capture the user gesture and the real-world view of the user. The one or more cameras may be embedded into the VST device 100 at different positions. A total number of the one or more cameras may be any number of cameras. In a non-limiting example, a total of ten to twelve cameras may be embedded into the VST device 100. The total number of cameras may be selected such as not to limit user's front view but by reviewing all areas and angles captured by the one or more cameras.

In a non-limiting example, the one or more cameras may include, but not limited to, RGB cameras, depth cameras, fisheye cameras, infrared cameras, eye tracking cameras, Simultaneous localization and Mapping (SLAM) cameras, or passthrough cameras. Further, the one or more cameras may be a wide angle camera, a narrow angle camera, or a 360 camera.

In an embodiment, each of the one or more cameras may have a different Field of View (FOV) based on camera parameters and placement of the one or more cameras within the VST device 100. The FOV for each camera among the one or more cameras may refers to the extent of a scene or area that the camera can capture. The FOV may be measured in degrees. The FOV may be represented as an imaginary cone extending from the camera lens with the apex at the camera lens itself. A wide FOV may allow the camera to capture a larger portion of the scene while a narrow FOV captures a smaller focused area. The narrow FOV may be around 20-30 degrees. The Wide FOV may range from 70-120 degrees. The ultra-wide FOV may be 120 degrees or higher. The 360 degrees F.OV may capture a complete spherical view. The FOV may be based on the camera parameters such as camera focal length and camera lens size. In an embodiment, the one or more cameras may have a setting to adjust the FOV of the one or more cameras, which allows the user to customize user's FOV.

The camera vision field engine 109 may receive the information associated with FOVs of the one or more cameras and the camera parameters from the multi camera unit 103. The camera vision field engine 109 may be configured to identify one or more overlaps between FOVs of the one or more cameras. The camera vision field engine 109 may identify one or more camera view zones based on the identified one or more overlaps between the FOVs of the one or more cameras.

The see through vision field segmentation engine 105 may identify one or more objects present in the content displayed on the glass frame. The content may correspond to the VR content or the AR content. The see through vision field segmentation engine 105 may identify the one or more objects present in each of the left frame and the right frame.

The gesture recognition module 107 may recognize the user gesture based on one or more images captured by the one or more cameras. The gesture recognition module 107 may use one or more gesture recognition techniques to recognize the user gesture.

The context generation module 111 may receive inputs from the see through vision field segmentation engine 105, the gesture recognition module 107, and the camera vision field engine 109. The context generation module 111 may determine one or more contexts based on an analysis of each of the one or more camera view zones. In an embodiment, one or more contexts may refer to the meaningful interpretation of user's surrounding environment and understanding the circumstances of current view. For example, one or more contexts may be what all is present in the surroundings (e.g. people, object, or so on), what is the role of the object or person in the current scenario or what a person is doing. For example, one or more contexts may include, but not limited to, street view, VR Meeting ongoing, AR objects of grocery, restaurant, person waving in user direction.

The command processing engine 113 may receive inputs from the context generation module 111. The command processing engine 113 may classify the one or more camera view zones for each of the determined one or more contexts.

The interaction engine 115 may receive inputs from the command processing engine 113. The interaction engine 115 may recognize a user gesture as an input based on the classified one or more camera view zones.

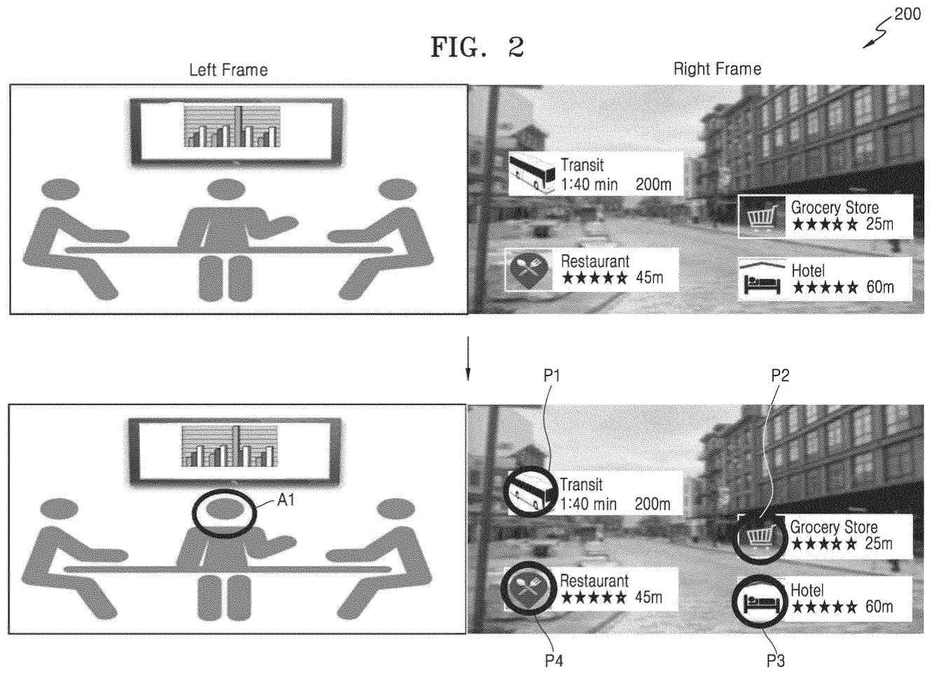

Now, a detailed description related to the see through vision field segmentation engine 105, the camera vision field engine 109, the context generation module 111, the command processing engine 113, and the interaction engine 115 of the VST device 100 will be explained in the forthcoming paragraphs along with the FIGS. 2 through 9 of the drawings.

In an embodiment, the see through vision field segmentation engine 105 may analyze the content displayed in the left frame and the right frame of the glass frame. The see through vision field segmentation engine 105 may determine a content type of the content displayed in the left frame and the right frame of the glass frame. The content type may correspond to one of the VR content, the AR content, the MR content, the XR content, or the real-world view. The VR content may be one of non-interactive or interactive content. The AR content may include one object or multiple objects. The MR content may include virtual and real-world elements. The XR content may include VR content, AR content, and MR content. In an embodiment, the see through vision field segmentation engine 105 may perform foreground segmentation of the displayed content to determine which avatar is in focus in the VR content and which all objects are present in the foreground in the AR content. In an embodiment, the see through vision field segmentation engine 105 may identify the one or more objects present in each of the left frame and the right frame based on the performed foreground segmentation.

FIG. 2 illustrates an example of a multi reality view 200 through a glass frame of the VST device 100, according to an embodiment. In the example view as shown in FIG. 2, the VR content may be displayed on the left frame, and the AR content may be displayed on the right frame. Also, as can be seen from FIG. 2, one avatar A1 is in focus in the VR content, and objects P1 to P4 are present in the AR content. The see through vision field segmentation engine 105 may identify these objects and output the information of the one or more objects to the context generation module 111. In a non-limiting example, the information output to the context generation module 111, in the above example, is given in Table 1 below.

TABLE 1
Objects in Vision Field

| | View | Number of | Identity of probable |
|---|---|---|---|
| View | Type | foreground objects | targets |
| Left | VR | 1 | Avatar [A1] |
| Right | AR | 4 | AR popups |
| | | | [P1, P2, P3, P4] |

The camera vision field engine 109 may comprise a camera FOV analysis module 109-1 and a camera view zone identification module 109-2.

In an embodiment, the camera FOV analysis module 109-1 may obtain (e.g. receive, capture, download) camera capability information and camera placement information of each of the one or more cameras from the multi camera unit 103. The camera FOV analysis module 109-1 may identify the FOV of each of one or more cameras based on the camera capability information of each of the one or more cameras. The camera capability information may include a camera focal length, a camera lens size, and a camera FOV of each of the one or more cameras. In an embodiment, the camera FOV analysis module 109-1 may generate a coverage map based on the identified FOV of each of the one or more cameras. The complete coverage map may be generated by combining the FOV of each of the one or more cameras.

In an embodiment, the camera FOV analysis module 109-1 may determine a relative position of the one or more cameras with respect to the center position of the glass frame based on the camera placement information of each of the one or more cameras. The camera placement information may include, but not limited to, a distance of a corresponding camera of the one or more cameras from the center position of the glass frame, a camera position, and a camera angle of each of the one or more cameras. In an embodiment, the camera FOV analysis module 109-1 may mark a coverage area in the coverage map, as one of a left area or a right area from the center position of the glass frame based on the determined relative position. By marking the coverage area in the coverage map, the coverage map may be divided into a left coverage map and a right coverage map. The information corresponding to the coverage map may be transferred to the camera view zone identification module 109-2.

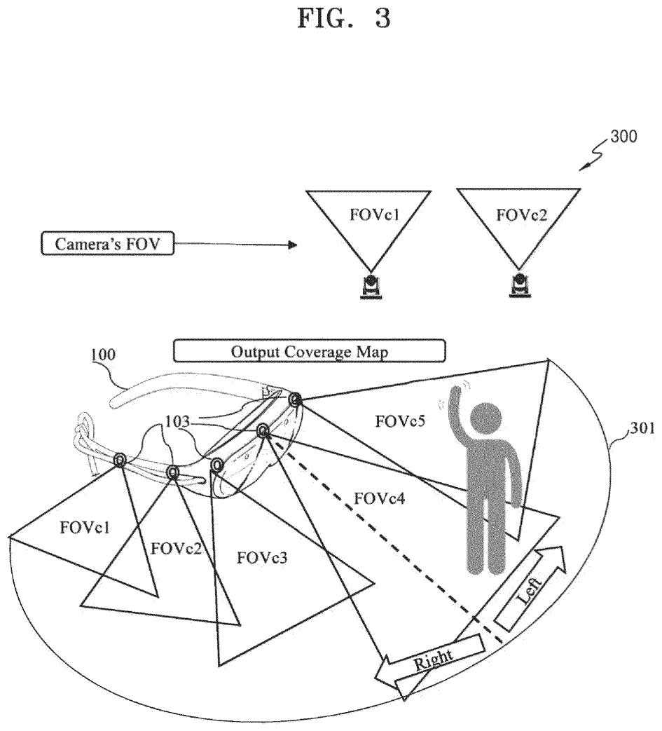

FIG. 3 illustrates an example diagram 300 depicting the coverage map generated by the camera field of view analysis module 109-1 of the VST device 100, according to an embodiment.

In the example shown in FIG. 3, the VST device 100 may include five cameras. The example shown in FIG. 3 is not intended to limit the scope of the present disclosure. In an example, the number of cameras may vary. As shown in FIG. 3, FOVc1 indicates FOV for camera 1, FOVc2 indicates FOV for camera 2, FOVc3 indicates FOV for camera 3, FOVc4 indicates FOV for camera 4, FOVc5 indicates FOV for camera 5. The coverage map 301 may be generated by combining an entire coverage range of the FOVc1 to FOVc5. The coverage map 301 may be then divided into the left coverage map and the right coverage map from the center position of the glass frame.

In an embodiment, the camera view zone identification module 109-2 may identify one or more overlaps between the identified FOVs of the one or more cameras in the generated coverage map. In an embodiment, the camera view zone identification module 109-2 may identify the one or more camera view zones within the coverage map based on the identified one or more overlaps between the identified FOVs. In an embodiment, the camera view zone identification module 109-2 may define the one or more view zones in the entirety of the coverage area. The camera view zone identification module 109-2 may define the one or more view zones in the left coverage map and the right coverage map in the coverage area. Each of the one or more cameras may have its FOV and the combination of the FOVs of each of the one or more cameras forms the coverage area. The coverage area may be divided into the one or more camera view zones. A camera view zone of the one or more camera view zones may be an overlapping region of the one or more FOVs. In an embodiment, the camera view zone may be a non-overlapping region of the one or more FOVs. In an embodiment, the camera view zone may be a combined region of the one or more FOVs. According to an example embodiment of the disclosure, the camera view zone may cover a region inside the glass frame of the VST device 100. According to an embodiment of the disclosure, the camera view zone may also cover a region outside the glass frame of the VST device 100.

In an embodiment, the camera view zone identification module 109-2 may identify (e.g. calculate, determine) the relative positions of the one or more camera view zones from the center position of the glass frame of the VST device 100. The camera view zone identification module 109-2 may also identify (e.g. calculate, determine) the relative positions of a camera view zone with respect to the other one or more camera view zones. The camera view zone identification module 109-2 may output zone relative position information that includes the FOV of the one or more cameras, the relative positions of the one or more camera view zones from the center position, relative positions of a camera view zone for each camera with respect to other camera view zones of other cameras among the one or more cameras.

In an embodiment, the camera view zone identification module 109-2 may generate zone overlap information for the one or more camera view zones by using the information associated with the coverage map received from the camera FOV analysis module 109-1. The zone overlap information may include information corresponding to the overlapped FOV and the zone boundary coordinates for each of the one or more camera view zones. The camera view zone identification module 109-2 may output the zone relative position information and the zone overlap information to the context generation module 111.

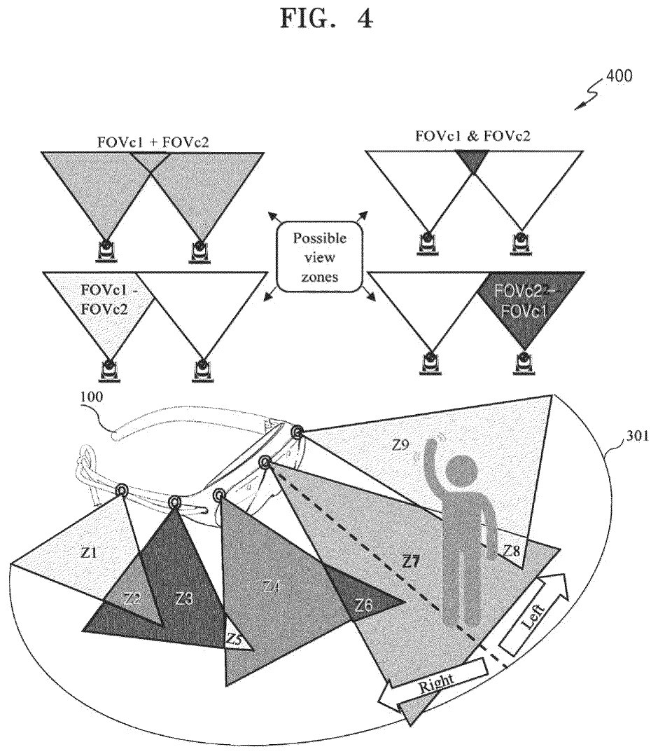

FIG. 4 illustrates an example 400 of defining one or more camera view zones in the coverage map by the camera view zone identification module 109-2 of the VST device 100, according to an embodiment. In a non-limiting example, four possible view zones are shown in FIG. 4 based on the overlap of camera FOVc1 and camera FOVc2. Also, as can be seen, from FIG. 4, the camera view zone identification module 109-2 may identify the nine camera view zones within the coverage map 301 based on the overlap between FOVc1, FOVc2, FOVc3, FOVc4, and FOVc5. These nine camera view zones Z1 to Z9 are defined in the entire coverage map 301.

In an embodiment, the context generation module 111 may include a gesture analysis module 111-1, a target identification module 111-3, and a correlated context establishment engine 111-5.

The gesture analysis module 111-1 may receive the information of the detected gesture from the gesture recognition module 107. The gesture analysis module 111-1 may also receive the zone relative position information and the zone overlap information from the camera view zone identification module 109-2.

The gesture analysis module 111-1 may analyze the meaning of the detected user gesture for the VR content, the AR content, the MR content, the XR content and the real-world view. The gesture analysis module 111-1 may create a gesture meaning map based on the analysis of the meaning of the detected user gesture. In an embodiment, the gesture analysis module 111-1 may generate and output a gesture meaning table based on the gesture meaning map. The gesture meaning table may include information of probable meanings of the detected user gesture for the VR content, the AR content, the MR content, the XR content and the real-world view.

The gesture analysis module 111-1 may determine a camera view zone among the one or more camera view zones in which the user gesture is detected. The gesture analysis module 111-1 may determine a coordinate of the camera view zone and a location of the camera view zone with respect to the center position of the glass frame. The gesture analysis module 111-1 may detect a position of the detected user gesture relative to a user's line of sight. In an embodiment, the gesture analysis module 111-1 may analyze the relevancy of the detected user gesture for the VR content, the AR content, MR content, XR content, and the real-world view. In an embodiment, the gesture analysis module 111-1 may generate and output a gesture relevancy table. The gesture relevancy table includes the relevancy factor of the gesture for the VR content, the AR content, MR content, XR content, and the real-world view.

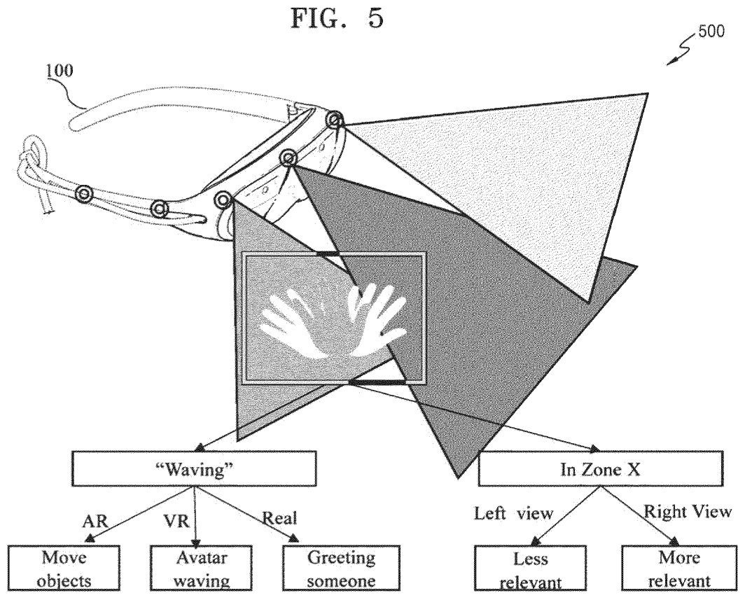

FIG. 5 illustrates an example 500 of analyzing the user gesture by the gesture analysis module 111-1 of the VST device 100, according to an embodiment disclosed herein.

As shown in FIG. 5, a user gesture as a waving gesture is detected in the right coverage map. The gesture analysis module 111-1 may analyze that the waving gesture for AR object is for moving the objects or for shaking the objects. The gesture analysis module 111-1 may analyze that the waving gesture for VR object is for copying the gesture. The gesture analysis module 111-1 may analyze that the waving gesture for real-world is a greeting. In an embodiment, gesture analysis module 111-1 may determine that the user gesture is less relevant for camera view zones in the left coverage map and more relevant to camera view zones in the right coverage map. In a non-limiting example, the output gesture meaning table and gesture relevancy table for the above example is shown below in Table 2 and Table 3.

TABLE 2
gesture meaning table

| Object/View | Probable Meaning |
|---|---|
| AR Object 1 | Move |
| AR Object 2 | Shake |
| VR Avatar 1 | Copy Gesture |
| Real-world 1 | Greet |

TABLE 3
gesture relevancy table

| Object/View | Zone | Relevancy Factor |
|---|---|---|
| AR Object 1 | Right | 90 |
| AR Object 2 | Left | 10 |
| VR Avatar 1 | Right | 90 |
| Real-world 1 | Left | 20 |

The target identification module 111-3 may receive inputs from the vision field segmentation engine 105, the translucent display unit 101, and the multi camera unit 103.

The target identification module 111-3 may receive information of the one or more objects present in each of the left frame and the right frame. In an embodiment, the target identification module 111-3 may detect the content displayed on the glass frame. In an embodiment, the target identification module 111-3 may detect the relative position of the AR objects and the VR objects in the glass frame. In an embodiment, the target identification module 111-3 may perform a contextual analysis of the content displayed on the left frame and the right frame.

In an embodiment, the target identification module 111-3 may also receive the output of the one or more cameras to detect the real-world view of the user. The target identification module 111-3 may determine a camera view zone corresponding to the real-world object. The target identification module 111-3 may perform the contextual analysis of the real-world object. In an embodiment, the target identification module 111-3 may determine the one or more contexts present in the displayed content and in the real-world object based on the contextual analysis.

In an embodiment, the target identification module 111-3 may identify, based on the determined one or more contexts and the identified one or more objects, one or more targets corresponding to the user gesture during the display of the content on the glass frame. The target identification module 111-3 may output a target and context input mapping table including the one or more targets, target positions, and the one or more contexts. The target identification module 111-3 may output information of the target and context input mapping table to the correlated context establishment engine 111-5.

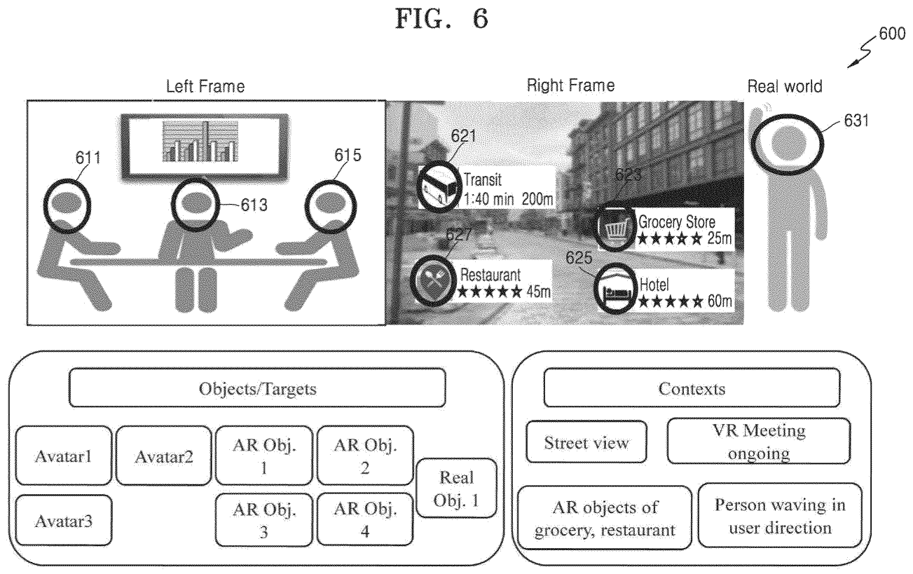

FIG. 6 illustrates an example 600 of identifying the one or more targets corresponding to the user gesture by the target identification module 111-3 of the VST device 100, according to an embodiment disclosed herein.

In a non-limiting example, as shown in FIG. 6, the VR content may be displayed on the left frame and the AR content is displayed on the right frame. In an embodiment, the user is also viewing the real-world view surrounding the user. The target identification module 111-3 may identify a number of objects that are present in the content displayed to the user and in the real-world view. In an example, three VR avatars 611, 613, 615, four AR objects 621, 623, 625, 627, and one real-world object 631 are present. In an embodiment, the target identification module 111-3 may determine four contexts that are present in the content displayed to the user and in the real-world view.

The target identification module 111-3 may identify four targets based on the determined four contexts. In a non-limiting example, the target identification module 111-3 may output a target and context input mapping table as shown in Table 4. Table 4 is merely an example and is not intended to limit the scope of the present disclosure.

TABLE 4
Target and context input mapping table

| | | View | Foreground/ |
|---|---|---|---|
| Target | Context | Zone | Background |
| AR Object 1 | AR objects of grocery on street view | Right | Yes |
| AR Object 2 | AR object of a restaurant on street | Right | Yes |
| | view | | |
| VR Avatar 1 | VR meeting ongoing | Left | No |
| Real-world 1 | Person waving in user's direction | Left | Yes |

As shown in Table 4, for AR object 1, the target identification module 111-3 may determine the context that the AR object 1 is an AR object of grocery on the street view. For AR object 2, the target identification module 111-3 may determine the context that the AR object 2 is the AR object of a restaurant on the street view. For VR avatar 1, the target identification module 111-3 may determine the context that a VR meeting is ongoing. For a real-world object, the target identification module 111-3 may determine the context that a person is waving in the user's direction.

The correlated context establishment engine 111-5 may receive the input from the gesture analysis module 111-1 and the target identification module 111-3. The correlated context establishment engine 111-5 may receive information associated with gesture meaning and gesture relevancy from the gesture analysis module 111-1. The correlated context establishment engine 111-5 may receive information associated with target and context input mapping from the target identification module 111-3.

The correlated context establishment engine 111-5 may correlate the one or more identified targets and the one or more contexts with the meaning of the gesture and the relevancy of the gesture.

In a non-limiting example, Table 5 shows an example of correlating the one or more identified targets and the one or more contexts with the meaning and relevancy of the gesture. Table 5 shows an example correlation table for the example scenarios shown in FIGS. 2 through 6.

TABLE 5
Gesture meaning and acceptance and rejection
probability mapping (correlation table)

| | | View | Probable | Relevancy |
|---|---|---|---|---|
| Target | Context | Zone | Meaning | Factor |
| AR Object 1 | AR objects of grocery on | Right | Move | 90 |
| | street view | | | |
| AR Object 2 | AR object of restaurant on | Right | Shake | 0 |
| | street view | | | |
| AR Object 2 | AR object of restaurant on | Right | Move | 50 |
| | street view | | | |
| VR Avatar 1 | VR meeting ongoing | Left | Copy Gesture | 90 |
| Real-world 1 | Person waving in user | Left | Greet | 20 |
| | direction | | | |

The correlated context establishment engine 111-5 may accept or reject the user gesture for one or more targets based on the correlation between the one or more identified targets and the one or more contexts. The correlated context establishment engine 111-5 may get the most probable gesture meaning for the target based on the correlation between the one or more identified targets and the one or more contexts identified from the correlation table.

In an embodiment, the command processing engine 113 may include a zone classification module 113-1, an input acceptance boundary cue engine 113-3, and an input acceptance boundary cue change engine 113-5.

The zone classification module 113-1 may receive information of the correlated one or more identified targets and the one or more contexts from the correlated context establishment engine 111-5. The zone classification module 113-1 may receive information corresponding to the one or more camera view zones from the camera vision field engine 109.

The zone classification module 113-1 may classify the one or more camera view zones into a plurality of groups of camera view zones. The zone classification module 113-1 may allocate each context of the one or more contexts a group of camera view zone from the plurality of groups of camera view zones. In an embodiment, the zone classification module 113-1 may classify, for the one or more contexts, the one or more camera view zones into the plurality of groups of camera view zones based on the correlation of the one or more identified targets and the one or more contexts. The zone classification module 113-1 may determine a required number of control zones based on a count of the one or more identified targets. The zone classification module 113-1 may output information corresponding to the plurality of groups of camera view zones and the required number of control zones to the input acceptance boundary cue engine 113-3.

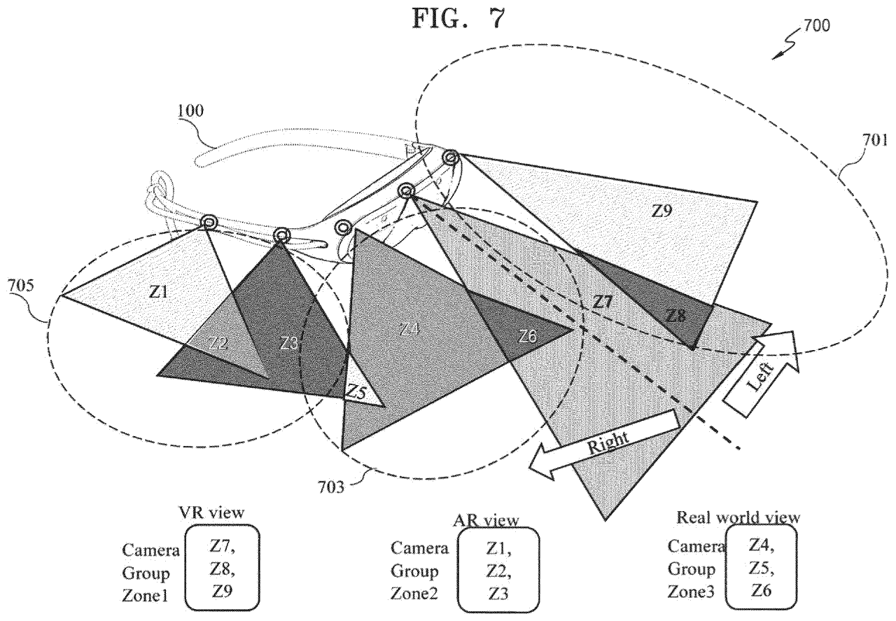

FIG. 7 illustrates an example 700 of classifying the one or more camera view zones by the zone classification module 113-1 of the VST device 100, according to an embodiment.

FIG. 7 shows an example of grouping the one or more camera view zones for the example scenario of FIGS. 2 to 6. The nine camera view zones may be divided into three groups of camera view zones. The camera view zone group-1 701 may be associated with the VR view, the camera view zone group-2 705 is associated with the AR view, and the camera view zone group-3 703 is associated with the real-world view. In an embodiment, each context as given in Table 5 may be allocated to one of the groups of camera view zones.

The input acceptance boundary cue engine 113-3 may obtain (e.g. receive, download, get) the information corresponding to the plurality of groups of camera view zones and the required number of control zones from the zone classification module 113-1.

The input acceptance boundary cue engine 113-3 may break the coverage area in the coverage map into N control zones. In an embodiment, the input acceptance boundary cue engine 113-3 may determine and allocate a size of each of the control zones. The input acceptance boundary cue engine 113-3 may allocate the input acceptance boundary for each of the one or more identified targets. The input acceptance boundary may be allocated for one of the acceptance or the rejection of the detected user gesture for each of the one or more identified targets. The allocation of the input acceptance boundary may be based on the plurality of groups of camera view zones and the required number of the control zones.

The input acceptance boundary cue engine 113-3 may determine whether the user gesture is within a range of the input acceptance boundary or outside the range of the input acceptance boundary. The input acceptance boundary cue engine 113-3 may accept or reject the user gesture for an identified target among the one or more identified targets if the detected user gesture is within the range of the input acceptance boundary. The input acceptance boundary cue engine 113-3 may accept the user gesture as an input for the identified target if the detected user gesture is within the input acceptance boundary allocated for the identified target. The acceptance of the user as the input for at least one target among the one or more identified targets may be based on the correlation and the allocated input acceptance boundary.

If it is determined that the detected user gesture is outside the range of the input acceptance boundary, the input acceptance boundary cue engine 113-3 may determine a requirement for a change in an input boundary cue.

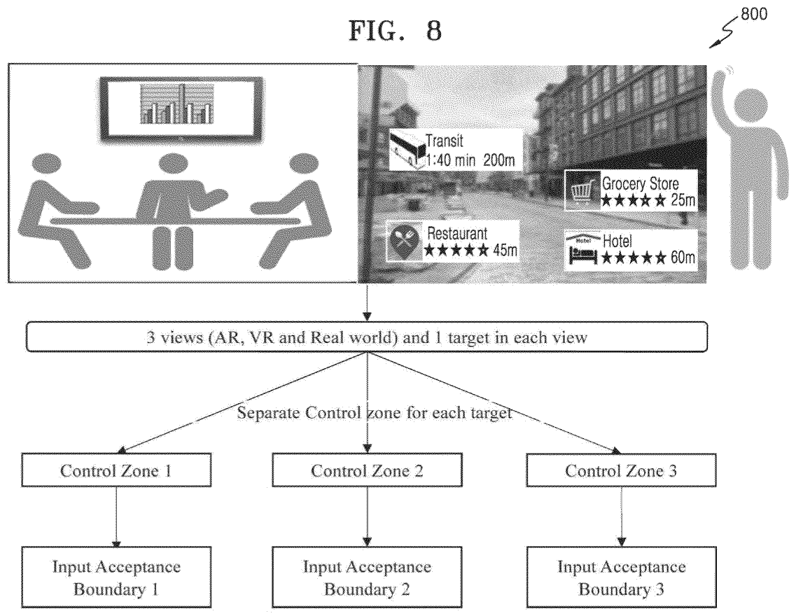

FIG. 8 illustrates an example 800 of allocating input acceptance boundary by the input acceptance boundary cue engine 113-3 of the VST device 100, according to an embodiment disclosed herein.

As shown in FIG. 8, the VR content is displayed on the left frame, and the AR content is displayed on the right frame. In an embodiment, the user is also viewing the real-world view surrounding the user. In an embodiment, it is identified that the at least one target is present within each of the VR view, the AR view, and the real-world view. In an example, the coverage area in the coverage map is divided into three control zones. In an embodiment, separate view zones provided for each target. In an embodiment, the input acceptance boundary may be allocated for each of the three identified targets in the three control zones.

In an embodiment, if the input boundary cue is required or a change in the input boundary cue is required, then the input acceptance boundary cue engine 113-3 may send this information to the interaction engine 115. In an embodiment, if the input acceptance boundary cue engine 113-3 accepts the user gesture for any of the identified targets among the one or more identified targets, then the input acceptance boundary cue engine 113-3 may send this information to the interaction engine 115.

The interaction engine 115 may include a frame view update module 115-1 and a zone view update module 115-3. The interaction engine 115 may obtain (e.g. receive, download, capture, get) the information that the user gesture is accepted for one of the identified targets. The interaction engine 115 may apply a gesture command on the identified target for which the user gesture is accepted. The interaction engine 115 may update the content to be displayed on the left frame and the right frame based on the gesture command. The interaction engine 115 may update the display of the content on the left frame and the right frame.

In an embodiment, if the interaction engine 115 obtain (e.g. receive, get, download) the information that the input boundary cue is required, the interaction engine 115 may display the input boundary cue to the user via the glass frame. In an embodiment, if the interaction engine 115 receives the information that the change in the input boundary cue is required, the interaction engine 115 may modify (e.g. update) the input boundary cue. In an embodiment, the interaction engine 115 may determine a position to display the input boundary cue. In an embodiment, the interaction engine 115 may display the input boundary cue to the determined position. The input boundary cue may correspond to an indication for performing the user gesture within the range of the input acceptance boundary.

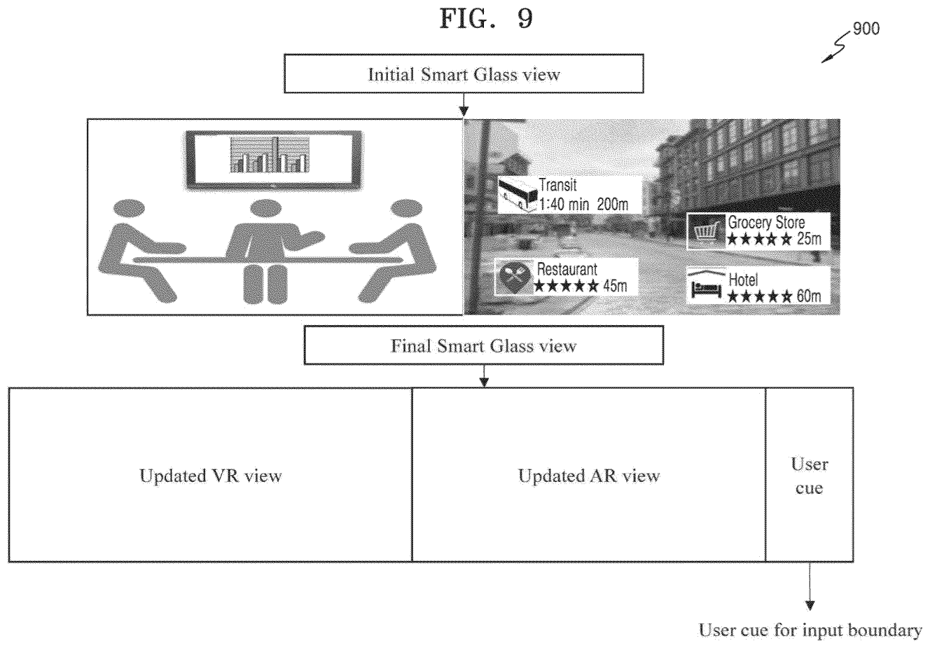

FIG. 9 illustrates an example 900 of displaying the input boundary cue for the input acceptance boundary by the interaction engine 115 of the VST device 100, according to an embodiment disclosed herein.

As shown in FIG. 9, the VR content is displayed on the left frame, and the AR content is displayed on the right frame. FIG. 9 may depict the input boundary cue that is displayed to the user when the interaction engine 115 obtain (e.g. receive, get, download) the information that the input boundary cue is required. The user cue for the input boundary may be shown in a small portion of the right frame. In an embodiment, if the user gesture is accepted for one of the identified targets, the AR view and the VR view may be modified.

In an embodiment, if target identification module 111-3 identifies that only one target is present, the interaction engine 115 may apply the gesture command to the identified target. In an embodiment, if target identification module 111-3 identifies that no target is present, then the detected user gesture may be rejected.

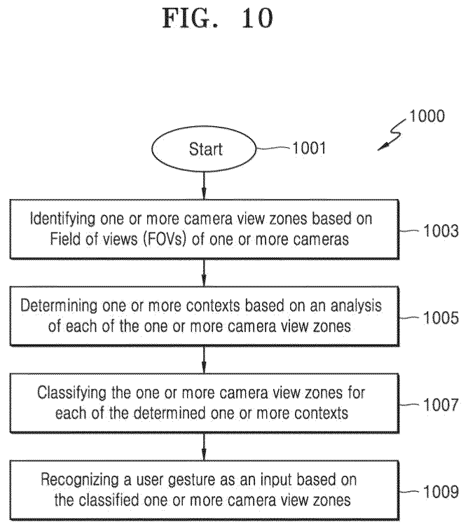

FIG. 10 illustrates a flow chart of a method 1000 for interpreting the user gestures in the multi-reality scenarios, according to an embodiment disclosed herein. The method 1000 may include a series of operations 1001 through 1009.

At step 1001, the content is displayed on the translucent display unit 101 of the VST device 100. The content may include, but not limited to, the VR content, the AR content, MR content, XR content, and the real-world view. The VST device 100 may include one or more cameras to capture the surroundings of the user of the VST device 100. The user of the VST device 100 may make a gesture while viewing the displayed content. The flow of the method 1000 now proceeds to step 1003.

At step 1003, the camera vision field engine 109 of the VST device 100 may identify one or more camera view zones based on the FOVs of one or more cameras. The flow of the method 1000 now proceeds to step 1005.

At step 1005, the context generation module 111 of the VST device 100 may determine one or more contexts based on the analysis of each of the one or more camera view zones. The context generation module 111 may analyze the VR content, the AR content, and the real-world view in each of the one or more camera view zones to determine the one or more contexts present in the VR content, the AR content, and the real-world view. The flow of the method 1000 now proceeds to step 1007.

At step 1007, the command processing engine 113 of the VST device 100 may classify the one or more camera view zones into a plurality of groups of camera view zones for each of the determined one or more contexts. The flow of the method 1000 now proceeds to step 1009.

At step 1009, the interaction engine 115 may recognize a user gesture as an input based on the classified one or more camera view zones. The interaction engine 115 may recognize the user gesture as the input for a target object in the content when the user gesture is detected in one group of camera view zone. The one group of the camera view zone may correspond to the context associated with the target object. The interaction engine 115 may apply a gesture command on the target object for which the user gesture is accepted.

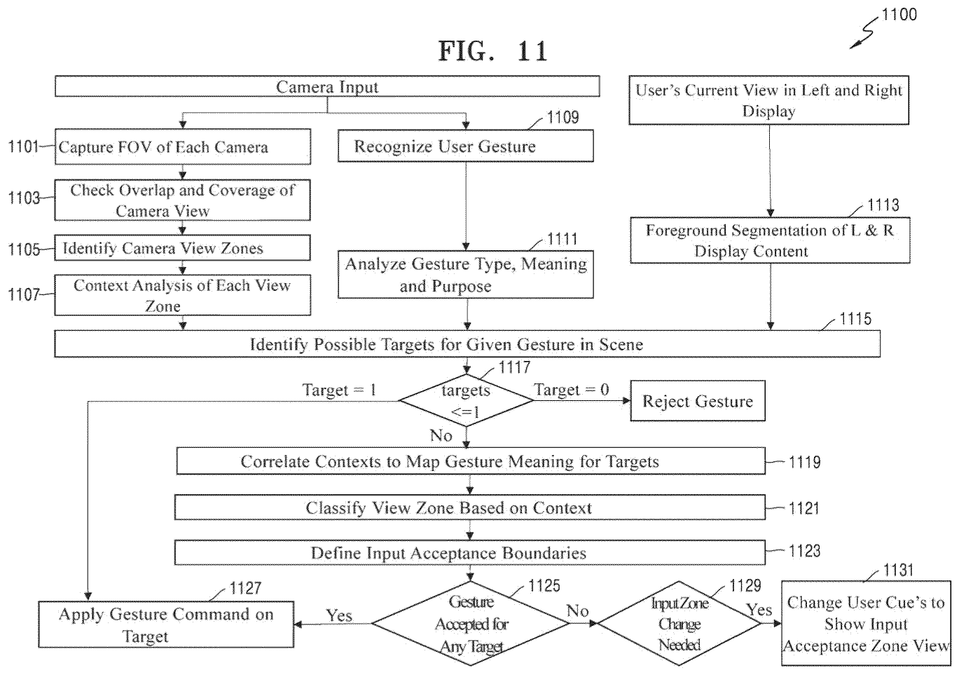

FIG. 11 illustrates a detailed flow chart of a method 1100 for interpreting the user gestures in the multi-reality scenarios, according to an embodiment disclosed herein. The method 1100 may include a series of operation steps 1101 through 1131.

In an embodiment, the content may be displayed on a glass frame of the translucent display unit 101 of the VST device 100. The content may include the VR content, the AR content, the MR content, the XR content and the real-world view. The VST device 100 may include one or more cameras to capture the surroundings of the user of the VST device 100.

At step 1101, the camera FOV analysis module 109-1 of the camera vision field engine 109 may identify the FOV of each of one or more cameras based on the camera capability information of each of the one or more cameras. The camera capability information may include the camera focal length, the camera lens size, and the camera FOV of each of the one or more cameras. The flow of the method 1100 now proceeds to step 1103.

At step 1103, the camera FOV analysis module 109-1 may check overlaps and coverage of view of each of one or more cameras. generate the coverage map combining the FOV of each of the one or more cameras. The flow of the method 1100 now proceeds to step 1105.

At step 1105, the camera view zone identification module 109-2 of the camera vision field engine 109 may identify one or more overlaps between the identified FOVs of the one or more cameras in the generated coverage map. The camera view zone identification module 109-2 may identify the one or more camera view zones within the coverage map based on the identified one or more overlaps between the identified FOVs. The flow of the method 1100 now proceeds to step 1107.

At step 1107, the target identification module 111-3 of the context generation module 111 may detect the content displayed on the glass frame. In an embodiment, the target identification module 111-3 may perform a contextual analysis of the content displayed on the left frame and the right frame. In an embodiment, the target identification module 111-3 also obtain (e.g. receive, download, capture) the output of the one or more cameras to detect the real-world view of the user. The target identification module 111-3 may perform the contextual analysis of the real-world object. In an embodiment, the target identification module 111-3 may determine the one or more contexts present in the displayed content and in the real-world object based on the contextual analysis. The flow of the method 1100 now proceeds to step 1115.

At step 1109, the gesture recognition module 107 may recognize the user gesture based on one or more images from the one or more cameras. The flow of the method 1100 from step 1109 proceeds to step 1111.

At step 1111, the gesture analysis module 111-1 of the context generation module 111 may receive the information of the detected gesture from the gesture recognition module 107. In an embodiment, the gesture analysis module 111-1 may analyze the meaning of the detected user gesture for the VR content, the AR content, the MR content, the XR content and the real-world view. In an embodiment, the gesture analysis module 111-1 may generate and output the gesture meaning table based on the gesture meaning map. The gesture meaning table may include information of probable meanings of the detected user gesture for the VR content, the AR content, MR content, XR content and the real-world view. In an embodiment, the gesture analysis module 111-1 may analyze the relevancy of the detected user gesture for the VR content, the AR content, and the real-world view. In an embodiment, the gesture analysis module 111-1 may generate and output the gesture relevancy table. The gesture relevancy table may include the relevancy factor of the gesture for the VR content, the AR content, and the real-world view. The flow of the method 1100 now proceeds to step 1115. The context generation module 111 may analyze the purpose of the detected user gesture for the VR content, the AR content, the MR content, the XR content, and the real-world view.

At another parallel step 1113, the see through vision field segmentation engine 105 may analyze the content displayed in the left frame and the right frame of the glass frame of the VST device 100. In an embodiment, the see through vision field segmentation engine 105 may identify the one or more objects present in each of the left frame and the right frame based on the analysis of the content. The flow of the method 1100 now proceeds to step 1115.

At step 1115, the target identification module 111-3 of the context generation module 111 may identify, based on the determined one or more contexts and the identified one or more objects, the one or more targets (i.e. possible targets) corresponding to the user gesture during the display of the content on the glass frame. The target identification module 111-3 may output the target and context input mapping table including the one or more targets, target positions, and the one or more contexts. The flow of the method 1100 now proceeds to step 1117.

At step 1117, the target identification module 111-3 may calculate a count of the identified one or more targets. If the number of identified one or more targets is only one, then the flow of the method proceeds to step 1127.

At step 1127, the interaction engine 115 may apply the gesture command to the identified target. At step 1117, if the target identification module 111-3 identifies that no target is present, the detected user gesture may be rejected. In an embodiment, if the count of the identified one or more targets is more than one, then the flow of the method 1100 proceeds to step 1119.

At step 1119, the correlated context establishment engine 111-5 of the context generation module 111 may correlate the one or more identified targets and the one or more contexts with the meaning of the gesture and the relevancy of the gesture. The flow of the method 1100 now proceeds to step 1121.

At step 1121, the zone classification module 113-1 of the command processing engine 113 may classify the one or more camera view zones into the plurality of groups of camera view zones. The zone classification module 113-1 may classify, for the one or more contexts, the one or more camera view zones into the plurality of groups of camera view zones based on the correlation of the one or more identified targets and the one or more contexts. The zone classification module 113-1 may determine the required number of control zones based on a count of the one or more identified targets. The flow of the method 1100 now proceeds to step 1123.

At step 1123, the input acceptance boundary cue engine 113-3 of the command processing engine 113 may break the coverage area in the coverage map into N control zones. In an embodiment, the input acceptance boundary cue engine 113-3 may determine and allocate a size of each of the control zones. The input acceptance boundary cue engine 113-3 may allocate the input acceptance boundary for each of the one or more identified targets. The input acceptance boundary may be allocated for one of the acceptance or the rejection of the detected user gesture for each of the one or more identified targets. The allocation of the input acceptance boundary may be based on the plurality of groups of camera view zones and the required number of the control zones. The input acceptance boundary cue engine 113-3 may define input acceptance boundaries. The flow of the method 1100 now proceeds to step 1125.

At step 1125, the input acceptance boundary cue engine 113-3 may determine whether the user gesture is accepted as an input for at least one identified target among the one or more identified targets. The input acceptance boundary cue engine 113-3 may accept the user gesture as the input for the at least one identified target if the user gesture is within the input acceptance boundary allocated for the corresponding target. The flow of the method 1100 now proceeds to step 1127. If it is determined that the user gesture is not accepted for any of the identified targets, then the flow of the method 1100 proceeds to step 1129.

At step 1127, the interaction engine 115 may receive the information that the user gesture is accepted for the one of the identified one or more targets. The interaction engine 115 may apply a gesture command on the at least one identified target for which the user gesture is accepted. The interaction engine 115 may modify the content to be displayed on the left frame and the right frame based on the gesture command.

At step 1129, if it is determined that the user gesture is not accepted, the interaction engine 115 may determine whether the input boundary cue change is required. If it is determined that the input boundary cue change is not required, then the interaction engine 115 may display the current input boundary cue to the user via the glass frame. In an embodiment, if it is determined that the input boundary cue change is required, then the flow of the method 1100 proceeds to step 1131.

At step 1131, if the interaction engine 115 receives the information that the change in the input boundary cue is required, then the interaction engine 115 may modify (e.g. change) the input boundary cue. In an embodiment, the interaction engine 115 may display (e.g. show) the input boundary cue to the user for the detected user gesture.

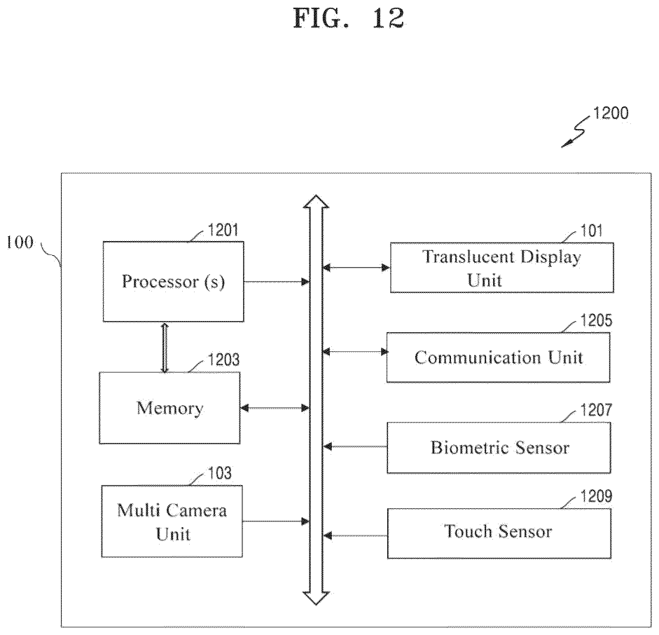

FIG. 12 illustrates an example hardware configuration of the VST device 100, according to an embodiment disclosed herein. The VST device 100 may include a processor 1201, a memory 1203, the multi camera unit 103, the translucent display unit 101, a communication unit 1205, a biometric sensor 1207, and a touch sensor 1209.

The processor 1201 may be a single processing unit or several units, all of which could include multiple computing units. The processor 1201 may be implemented as one or more microprocessors, microcomputers, microcontrollers, digital signal processors, central processing units, state machines, logic circuitries, and/or any devices that manipulate signals based on operational instructions. Among other capabilities, the processor 1201 may be configured to fetch and execute computer-readable instructions and data stored in the memory 1203.

The memory 1203 may include one or more computer-readable storage media. The memory 1203 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

The memory 1203 may include any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The translucent display unit 101 may be configured to display the content to the user associated with the VST device 100. The translucent display unit 101 may include a glass frame. The glass frame has a left frame and a right frame. As a non-limiting example, the translucent display unit 101 may be a transparent OLED display screen, a transparent LED display screen, and any other similar kind of transparent display. The display screen may be of varied resolutions.

The multi camera unit 103 may include one or more cameras configured to capture a user gesture and the real-world view of the user. The one or more cameras may be embedded into the VST device 100 at different positions. The number of cameras in the one or more cameras may be any number of cameras.

The communication unit 1205 may be configured to communicate voice, video, audio, images, or any other digital media content over a communication network. In an embodiment, the communication unit 1205 may include a communication port or a communication interface for sending and receiving notifications from the VST device 100 via the communication network. The communication port or the communication interface may be a part of a processing unit or may be a separate component. The communication port may be created in software or may be a physical connection in hardware. The communication port may be configured to connect with the communication network, external media, the translucent display unit 101, or any other components in the VST device 100, or combinations thereof. The connection with the communication network may be a physical connection, such as a wired Ethernet connection, or may be established wirelessly as discussed above. Likewise, the additional connections with other components of the VST device 100 may be physical or may be established wirelessly.

The biometric sensor 1207 may be configured to capture biometric data of the user of the VST device 100. The biometric data may include facial recognition, palm prints, or iris scans, but also extends to other similar types of scans. The one or more cameras of the multi camera unit 103 may be a part of the biometric sensor 1207. The touch sensor 1209 in the VST device 100 may include, but is not limited to, haptic sensors. The haptic sensor recreates the sense of touch when the user interacts with the VST device 100.

In an example, the module(s) and/or the unit(s) and/or model(s) may include a program, a subroutine, a portion of a program, a software component, or a hardware component capable of performing a stated task or function. As used herein, the module(s) and/or the unit(s) and/or model(s) may be implemented on a hardware component such as a server independently of other modules, or a module can exist with other modules on the same server, or within the same program. The module(s) and/or unit(s) and/or model(s) may be implemented on a hardware component such as processor one or more microprocessors, microcomputers, microcontrollers, digital signal processors, central processing units, state machines, logic circuitries, and/or any devices that manipulate signals based on operational instructions. The module(s) and/or unit(s) and/or model(s), when executed by the processor(s), may be configured to perform any of the described functionalities.

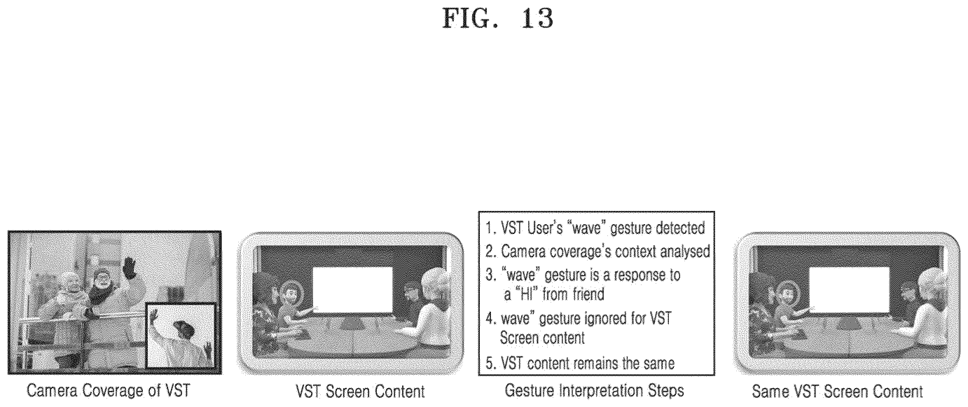

FIG. 13 illustrates a scenario of interpreting the user gestures in the multi-reality scenarios, according to an embodiment. FIG. 13A illustrates a scenario when the one or more contexts are analyzed. When the user of the VST device gestures (e.g. waves), the VST device may identify (e.g. detect) a user gesture. The VST device may determine (e.g. analyze) one or more contexts based on an analysis of each of the one or more camera view zones. The VST device may analyze a meaning of the detected user gesture for the VR content, the AR content, the MR content, the XR content, and a real-world view. The VST device may recognize the user gesture as a response to a “HI” from friend, who is in a real-world view. The VST device may recognize the user gesture as an input in a real-world view. The VST device may ignore the user gesture as an input for the VR content for the VST device. The VR content of the VST device may be not modified (e.g. updated).

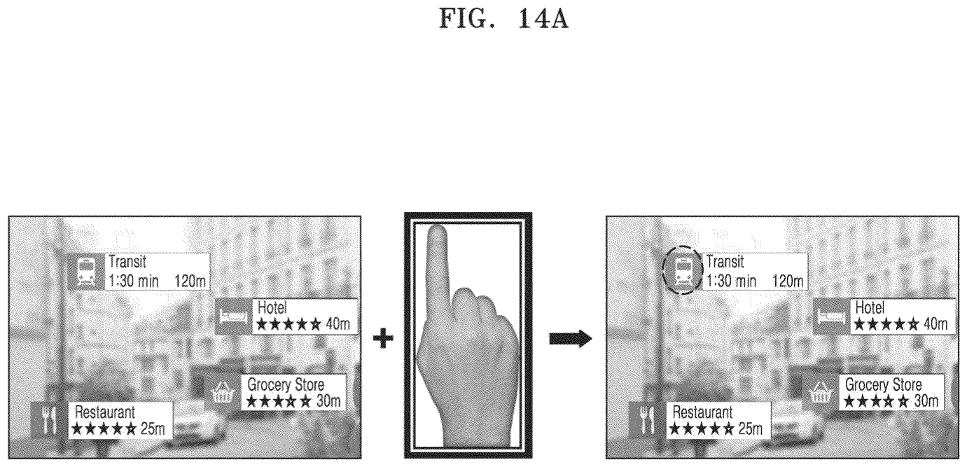

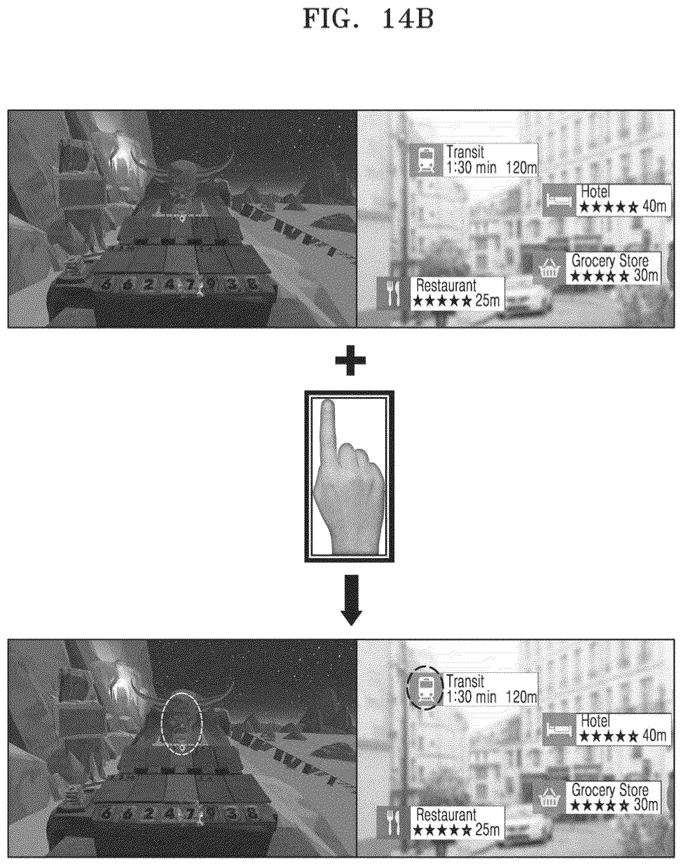

FIGS. 14A-14B illustrate a scenario when the user gesture is used to select the object from one or more objects, according to an embodiment. FIG. 14A illustrates a scenario when one or more objects are shown in the view of the VST device, and a user make a finger point gesture, the finger point gesture may be used to show a cursor around AR objects in frame and may be used to select one of the objects.

FIG. 14B illustrates a scenario when a VR content (e.g. VR game) is being played as well as one or more objects in the AR content are being shown simultaneously on the VST device. If a user makes a gesture (e.g. a finger point gesture), the gesture may be used to show a cursor on the translucent display unit of the VR content as well as the translucent display unit of the AR content. In this case, the VST device may be received user cue about separate input acceptance boundary for both cases. The VST device may be received the user's choice of giving input for the one or more contents.

One aspect of the above-disclosed method is to effectively handle various interactions in the VST device 100 through gesture recognition. In situations where the target object is not clear based on the detected user gesture, the above-disclosed VST device 100 may understand the intended target for the detected user gesture and resolves any ambiguity by itself or by notifying the user of such conflicting scenarios.

Another aspect of the above-disclosed method is to interpret the detected user gestures and dynamically adjust the interpretation of the detected user gestures based on contextual information in the multi reality scenario.

The various actions, acts, blocks, steps, or the like in the flow diagrams may be performed in the order presented, in a different order, or simultaneously. Further, in an embodiment, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While language has been used to describe the present subject matter, any limitations arising on account thereto, are not intended. As would be apparent to a person in the art, various working modifications may be made to the method to implement an embodiment as taught herein. The drawings and the foregoing description give examples of embodiments. Those skilled in the art will appreciate that one or more of the described elements may well be combined into a single functional element. Alternatively, elements may be split into multiple functional elements. Elements from one embodiment may be added to another embodiment.

An embodiment disclosed herein can be implemented using at least one hardware device and performing network management functions to control the elements.

The foregoing description of the example embodiments is provided to describe an embodiment herein that others can, by applying current knowledge, readily modify and/or adapt for various applications such example embodiment without departing from the concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while an embodiment herein have been described in terms of embodiment, those skilled in the art will recognize that an embodiment herein can be practiced with modification within the scope of an embodiment as described herein.

According to an aspect of the disclosure, there is provided method, implemented in a Visual See Through (VST) device, for interpreting user gestures in multi-reality scenarios. The method may include identifying one or more camera view zones based on fields of view (FOVs) of one or more cameras. The method may include determining one or more contexts based on an analysis of each of the one or more camera view zones. The method may include classifying the one or more camera view zones for each of the determined one or more contexts. The method may include recognizing a user gesture as an input based on the classified one or more camera view zones.

According to an embodiment of the disclosure, the method may include identifying one or more objects present in content displayed on a glass frame of the VST device. The method may include identifying, based on the determined one or more contexts and the identified one or more objects, one or more targets corresponding to the user gesture while the content is displayed on the glass frame. The method may include correlating the identified one or more targets with the one or more contexts The method may include allocating, based on the classifying the one or more camera view zones for each of the determined one or more contexts, an input acceptance boundary for each of the identified one or more targets, wherein the recognition of the user gesture as the input for at least one target among the identified one or more targets may be further based on the correlation and the allocated input acceptance boundary.

The determining the one or more contexts may include analyzing, in each of the one or more camera view zones, the displayed content and a user see through view, wherein the user see through view corresponds to a real-world view through a glass frame of the VST device. The method may include determining the one or more contexts present in the displayed content and the user see through view based on the analysis of the displayed content and the user see through view in each of the one or more camera view zones.

The method may include identifying the FOV of each of one or more cameras based on a plurality of first camera parameters of each of the one or more cameras. The method may include generating a coverage map based on the identified FOV of each of the one or more cameras. The method may include determining a relative position of the one or more cameras with respect to a center position of a glass frame of the VST device based on a plurality of second camera parameters of each of the one or more cameras. The method may include marking, a coverage area in the coverage map, as one of a left area or a right area from the center position of the glass frame based on the determined relative position. The plurality of first camera parameters may include a camera focal length, a camera lens size, and a camera FOV. The plurality of second camera parameters may include a distance of a corresponding camera of the one or more cameras from the center position of the glass frame, a camera position, and an angle associated with the corresponding camera.

According to an embodiment of the disclosure, the method may include identifying one or more overlaps between the identified FOVs of the one or more cameras in the generated coverage map. The method may include identifying the one or more camera view zones within the coverage map based on the identified one or more overlaps between the identified FOVs. The method may include defining the one or more view zones in an entirety of the coverage area. The method may include identifying relative positions of the one or more camera view zones from the center position of the glass frame of the VST device. The method may include generating zone overlap information for each camera view zone of the one or more camera view zones based on the relative position of the one or more camera view zones.

According to an embodiment of the disclosure, the method may include analyzing the content displayed on a left frame and a right frame of the glass frame. The method may include determining a content type of the displayed content. The content type may correspond to at least one of virtual reality (VR) content or augmented reality (AR) content. The method may include performing foreground segmentation of the displayed content through the left frame and the right frame. The method may include identifying the one or more objects present in each of the left frame and the right frame based on the performed foreground segmentation.

According to an embodiment of the disclosure, the method may include detecting the user gesture using the one or more cameras. The method may include analyzing a meaning of the detected user gesture for virtual reality (VR) content, augmented reality (AR) content, and a real-world view. The method may include creating a gesture meaning table based on the analyzed meaning of the detected user gesture. The gesture meaning table may include information of probable meanings of the detected user gesture for the VR content, the AR content, and the real-world view. The method may include detecting a position of the detected user gesture relative to a user's line of sight. The method may include analyzing the relevancy of the detected user gesture for the VR content, the AR content, and the real-world view based on the position of the detected user gesture relative to the user's line of sight.

The correlating the identified one or more targets with the one or more contexts may include correlating the identified one or more targets with the one or more contexts based on the meaning of the detected user gesture and the relevancy of the detected user gesture.

According to an embodiment of the disclosure, the method may include determining that only one target is identified. The method may include applying a command on the identified target based on the analyzed meaning for the detected user gesture.

According to an embodiment of the disclosure, the method may include rejecting the detected user gesture based on no target being identified.

According to an embodiment of the disclosure, the allocating the input acceptance boundary may include classifying, for the one or more contexts, the one or more camera view zones into one or more groups of camera view zones based on the correlation of the one or more contexts with the identified one or more target. The method may include determining a required number of control zones based on a count of the identified one or more targets; and allocating the input acceptance boundary for one of acceptance or rejection of the detected user gesture based on the one or more groups of camera view zones and the required number of the control zones.

According to an embodiment of the disclosure, the method may include determining whether the user gesture is within a range of the input acceptance boundary or outside the range of the input acceptance boundary. The method may include based on determining the that the user gesture is outside the range of the input acceptance boundary, determining a requirement for a change in an input boundary cue. The method may include, based on determining the requirement for the change in the input boundary cue. The method may include, displaying the input boundary cue on the glass frame to indicate the input acceptance boundary to the user. The input boundary cue may correspond to an indication for performing the user gesture within the range of the input acceptance boundary.

According to an aspect of the disclosure, there is provided a Visual See Through (VST) device for interpreting user gestures in multi-reality scenarios. The VST device may include one or more cameras. The VST device may include memory configured to store instructions. The VST device may include one or more processors, wherein the instructions, when executed by the one or more processors, cause the VST device to identify one or more camera view zones based on fields of view (FOVs) of one or more cameras. The VST device may include one or more processors, wherein the instructions, when executed by the one or more processors, cause the VST device to determine one or more contexts based on an analysis of each of the one or more camera view zones. The VST device may include one or more processors, wherein the instructions, when executed by the one or more processors, cause the VST device to classify the one or more camera view zones for each of the determined one or more contexts. The VST device may include one or more processors, wherein the instructions, when executed by the one or more processors, cause the VST device to recognize a user gesture as an input based on the classified one or more camera view zones.

The instructions, when executed by the one or more processors, may cause the VST device to identify one or more objects present in a content displayed on a glass frame of the VST device. The instructions, when executed by the one or more processors, may cause the VST device to identify, based on the determined one or more contexts and the identified one or more objects, one or more targets corresponding to the user gesture while the content is displayed on the glass frame. The instructions, when executed by the one or more processors, may cause the VST device to correlate the identified one or more targets with the one or more contexts; and allocate, based on the classifying the one or more camera view zones for each of the determined one or more contexts, an input acceptance boundary for each of the identified one or more targets, wherein the recognition of the user gesture as the input for at least one target among the identified one or more targets may be further based on the correlation and the allocated input acceptance boundary.

To determine the one or more contexts, the instructions, when executed by the one or more processors, may cause the VST device to analyze, in each of the one or more camera view zones, the displayed content and a user see through view, wherein the user see through view corresponds to a real-world view through a glass frame of the VST device. To determine the one or more contexts, the instructions, when executed by the one or more processors, may cause the VST device to determine the one or more contexts present in the displayed content and the user see through view based on the analysis of the displayed content and the user see through view in each of the one or more camera view zones.

The instructions, when executed by the one or more processors, may cause the VST device to analyze the content displayed on a left frame and a right frame of the glass frame. The instructions, when executed by the one or more processors, may cause the VST device to determine a content type of the displayed content, wherein the content type corresponds to at least one of virtual reality (VR) content or augmented reality (AR) content. The instructions, when executed by the one or more processors, may cause the VST device to perform foreground segmentation of the displayed content through the left frame and the right frame; and identify the one or more objects present in each of the left frame and the right frame based on the performed foreground segmentation.

The instructions, when executed by the one or more processors, may further cause the VST device to detect the user gesture using the one or more cameras. The instructions, when executed by the one or more processors, may cause the VST device to analyze a meaning of the detected user gesture for virtual reality (VR) content, augmented reality (AR) content, and a real-world view. The instructions, when executed by the one or more processors, may cause the VST device to create a gesture meaning table based on the analyzed meaning of the detected user gesture, wherein the gesture meaning table may include information of probable meanings of the detected user gesture for the VR content, the AR content, and the real-world view. The instructions, when executed by the one or more processors, may cause the VST device to detect a position of the detected user gesture relative to a user's line of sight. The instructions, when executed by the one or more processors, may cause the VST device to analyze the relevancy of the detected user gesture for the VR content, the AR content, and the real-world view based on the position of the detected user gesture relative to the user's line of sight.

To correlate the identified one or more targets with the one or more contexts, the instructions, when executed by the one or more processors, may cause the VST device to correlate the identified one or more targets with the one or more contexts based on the meaning of the detected user gesture and the relevancy of the detected user gesture.

To allocate the input acceptance boundary, the instructions, when executed by the one or more processors, may cause the VST device to classify, for the one or more contexts, the one or more camera view zones into one or more groups of camera view zones based on the correlation of the one or more contexts with the identified one or more targets. The instructions, when executed by the one or more processors, may cause the VST device to determine a required number of control zones based on a count of the identified one or more targets; and allocate the input acceptance boundary for one of the acceptance or the rejection of the detected user gesture based on the one or more groups of camera view zones and the required number of the control zones.

The instructions, when executed by the one or more processors, may cause the VST device to determine whether the user gesture is within a range of the input acceptance boundary or outside the range of the input acceptance boundary. The instructions, when executed by the one or more processors, may cause the VST device to, based on determining that the user gesture is outside the range of the input acceptance boundary, determine a requirement for a change in an input boundary cue. The instructions, when executed by the one or more processors, may cause the VST device to, based on the determining the requirement for the change in the input boundary cue, display the input boundary cue on the glass frame to indicate the input acceptance boundary to the user, wherein the input boundary cue corresponds to an indication for performing the user gesture within the range of the input acceptance boundary.

According to an aspect of the disclosure, there is provided a Visual See Through (VST) device for interpreting user gestures in multi-reality scenarios. The VST device may include memory configured to store instructions. The VST device may include one or more processors, wherein the instructions, when executed by the one or more processors, cause the VST device to identify one or more camera view zones based on fields of view (FOVs) of one or more cameras. The VST device may include one or more processors, wherein the instructions, when executed by the one or more processors, cause the VST device to determine one or more contexts based on an analysis of each of the one or more camera view zones. The VST device may include one or more processors, wherein the instructions, when executed by the one or more processors, cause the VST device to classify the one or more camera view zones for each of the determined one or more contexts. The VST device may include one or more processors, wherein the instructions, when executed by the one or more processors, cause the VST device to recognize a user gesture as an input based on the classified one or more camera view zones.

The instructions, when executed by the one or more processors, may cause the VST device to identify one or more objects present in content displayed on a glass frame of the VST device. The instructions, when executed by the one or more processors, may cause the VST device to identify, based on the determined one or more contexts and the identified one or more objects, one or more targets corresponding to the user gesture while the content is displayed on the glass frame. The instructions, when executed by the one or more processors, may cause the VST device to correlate the identified one or more targets with the one or more contexts; and allocate, based on the classifying the one or more camera view zones for each of the determined one or more contexts, an input acceptance boundary for each of the identified one or more targets, wherein the recognition of the user gesture as the input for at least one target among the identified one or more targets is further based on the correlation and the allocated input acceptance boundary.

The instructions, when executed by the one or more processors, may cause the VST device to detect the user gesture using one or more cameras. The instructions, when executed by the one or more processors, may cause the VST device to analyzing a meaning of the detected user gesture for virtual reality (VR) content, augmented reality (AR) content, and a real-world view. The instructions, when executed by the one or more processors, may cause the VST device to create a gesture meaning table based on the analyzed meaning of the detected user gesture. The gesture meaning table may include information of probable meanings of the detected user gesture for the VR content, the AR content, and the real-world view. The instructions, when executed by the one or more processors, may cause the VST device to detect a position of the detected user gesture relative to a user's line of sight. The instructions, when executed by the one or more processors, may cause the VST device to analyze the relevancy of the detected user gesture for the VR content, the AR content, and the real-world view based on the position of the detected user gesture relative to the user's line of sight.

The correlating the identified one or more targets with the one or more contexts may include correlating the identified one or more targets with the one or more contexts based on the meaning of the detected user gesture and the relevancy of the detected user gesture.

The instructions, when executed by the one or more processors, may cause the VST device to determine that only one target is identified. The instructions, when executed by the one or more processors, may cause the VST device to apply a command on the identified target based on the analyzed meaning for the detected user gesture.

What is claimed is:

1. A method, implemented in a Visual See Through (VST) device, the method comprising:
identifying one or more camera view zones based on fields of view (FOVs) of one or more cameras;
determining one or more contexts based on an analysis of each of the one or more camera view zones;
classifying the one or more camera view zones for each of the determined one or more contexts; and
recognizing a user gesture as an input based on the classified one or more camera view zones.

2. The method as claimed in claim 1, further comprising:
identifying one or more objects present in content displayed on a glass frame of the VST device;
identifying, based on the determined one or more contexts and the identified one or more objects, one or more targets corresponding to the user gesture while the content is displayed on the glass frame;
correlating the identified one or more targets with the one or more contexts; and
allocating, based on the classifying the one or more camera view zones for each of the determined one or more contexts, an input acceptance boundary for each of the identified one or more targets, wherein the recognition of the user gesture as the input for at least one target among the identified one or more targets is further based on the correlation and the allocated input acceptance boundary.

3. The method as claimed in claim 1, wherein, the determining the one or more contexts comprises:
analyzing, in each of the one or more camera view zones, the displayed content and a user see through view, wherein the user see through view corresponds to a real-world view through a glass frame of the VST device; and
determining the one or more contexts present in the displayed content and the user see through view based on the analysis of the displayed content and the user see through view in each of the one or more camera view zones.

4. The method as claimed in claim 1, further comprising:
identifying the FOV of each of one or more cameras based on a plurality of first camera parameters of each of the one or more cameras;
generating a coverage map based on the identified FOV of each of the one or more cameras;
determining a relative position of the one or more cameras with respect to a center position of a glass frame of the VST device based on a plurality of second camera parameters of each of the one or more cameras; and
marking, a coverage area in the coverage map, as one of a left area or a right area from the center position of the glass frame based on the determined relative position,
wherein the plurality of first camera parameters includes a camera focal length, a camera lens size, and a camera FOV, and
wherein the plurality of second camera parameters includes a distance of a corresponding camera of the one or more cameras from the center position of the glass frame, a camera position, and an angle associated with the corresponding camera.

5. The method as claimed in claim 4, further comprising:
identifying one or more overlaps between the identified FOVs of the one or more cameras in the generated coverage map;
identifying the one or more camera view zones within the coverage map based on the identified one or more overlaps between the identified FOVs;
defining the one or more view zones in an entirety of the coverage area;
identifying relative positions of the one or more camera view zones from the center position of the glass frame of the VST device; and
generating zone overlap information for each camera view zone of the one or more camera view zones based on the relative position of the one or more camera view zones.

6. The method as claimed in claim 2, further comprising:
analyzing the content displayed on a left frame and a right frame of the glass frame;
determining a content type of the displayed content, wherein the content type corresponds to at least one of virtual reality (VR) content or augmented reality (AR) content;
performing foreground segmentation of the displayed content through the left frame and the right frame; and
identifying the one or more objects present in each of the left frame and the right frame based on the performed foreground segmentation.

7. The method as claimed in claim 2, further comprising:
detecting the user gesture using the one or more cameras;
analyzing a meaning of the detected user gesture for virtual reality (VR) content, augmented reality (AR) content, and a real-world view;
creating a gesture meaning table based on the analyzed meaning of the detected user gesture, wherein the gesture meaning table comprises information of probable meanings of the detected user gesture for the VR content, the AR content, and the real-world view;
detecting a position of the detected user gesture relative to a user's line of sight; and
analyzing the relevancy of the detected user gesture for the VR content, the AR content, and the real-world view based on the position of the detected user gesture relative to the user's line of sight.

8. The method as claimed in claim 7, wherein the correlating the identified one or more identified targets with the one or more contexts comprises correlating the identified one or more identified targets with the one or more contexts based on the meaning of the detected user gesture and the relevancy of the detected user gesture.

9. The method as claimed in claim 7, further comprising:
determining that only one target is identified; and
applying a command on the identified target based on the analyzed meaning for the detected user gesture.

10. The method as claimed in claim 2, further comprising rejecting the detected user gesture when based on no target is being identified.

11. The method as claimed in claim 2, wherein the allocating the input acceptance boundary comprises:
classifying, for the one or more contexts, the one or more camera view zones into one or more groups of camera view zones based on the correlation of the one or more contexts with the identified one or more targets;
determining a required number of control zones based on a count of the identified one or more targets; and
allocating the input acceptance boundary for one of acceptance or rejection of the detected user gesture based on the one or more groups of camera view zones and the required number of the control zones.

12. The method as claimed in claim 2, further comprising:
determining whether the user gesture is within a range of the input acceptance boundary or outside the range of the input acceptance boundary;
based on determining the that the user gesture is outside the range of the input acceptance boundary, determining a requirement for a change in an input boundary cue; and
based on determining the requirement for the change in the input boundary cue, displaying the input boundary cue on the glass frame to indicate the input acceptance boundary to the user, wherein the input boundary cue corresponds to an indication for performing the user gesture within the range of the input acceptance boundary.

13. A Visual See Through (VST) device comprising:
one or more cameras;
memory configured to store instructions; and
one or more processors,
wherein the instructions, when executed by the one or more processors, cause the VST device to:
identify one or more camera view zones based on fields of view (FOVs) of one or more cameras;
determine one or more contexts based on an analysis of each of the one or more camera view zones;
classify the one or more camera view zones for each of the determined one or more contexts; and
recognize a user gesture as an input based on the classified one or more camera view zones.

14. The VST device as claimed in claim 13, wherein the instructions, when executed by the one or more processors, further cause the VST device to:
identify one or more objects present in a content displayed on a glass frame of the VST device;
identify, based on the determined one or more contexts and the identified one or more objects, one or more targets corresponding to the user gesture while the content is displayed on the glass frame;
correlate the identified one or more targets with the one or more contexts; and
allocate, based on the classifying the one or more camera view zones for each of the determined one or more contexts, an input acceptance boundary for each of the identified one or more targets, wherein the recognition of the user gesture as the input for at least one target among the identified one or more targets is further based on the correlation and the allocated input acceptance boundary.

15. The VST device as claimed in claim 13, wherein, to determine the one or more contexts, the instructions, when executed by the one or more processors, further cause the VST device to:
analyze, in each of the one or more camera view zones, the displayed content and a user see through view, wherein the user see through view corresponds to a real-world view through a glass frame of the VST device; and
determine the one or more contexts present in the displayed content and the user see through view based on the analysis of the displayed content and the user see through view in each of the one or more camera view zones.

16. The VST device as claimed in claim 14, wherein the instructions, when executed by the one or more processors, further cause the VST device to:
analyze the content displayed on a left frame and a right frame of the glass frame;
determine a content type of the displayed content, wherein the content type corresponds to at least one of virtual reality (VR) content or augmented reality (AR) content;
perform foreground segmentation of the displayed content through the left frame and the right frame; and
identify the one or more objects present in each of the left frame and the right frame based on the performed foreground segmentation.

17. The VST device as claimed in claim 14, wherein the instructions, when executed by the one or more processors, further cause the VST device to:
detect the user gesture using the one or more cameras;
analyze a meaning of the detected user gesture for virtual reality (VR) content, augmented reality (AR) content, and a real-world view;
create a gesture meaning table based on the analyzed meaning of the detected user gesture, wherein the gesture meaning table comprises information of probable meanings of the detected user gesture for the VR content, the AR content, and the real-world view;
detect a position of the detected user gesture relative to a user's line of sight; and
analyze the relevancy of the detected user gesture for the VR content, the AR content, and the real-world view based on the position of the detected user gesture relative to the user's line of sight.

18. The VST device as claimed in claim 17, wherein to correlate the identified one or more identified targets with the one or more contexts, the instructions, when executed by the one or more processors, further cause the VST device to the one or more processors (1201) are further configured to correlate the identified one or more identified targets with the one or more contexts based on the meaning of the detected user gesture and the relevancy of the detected user gesture.

19. The VST device as claimed in claim 14, wherein to allocate the input acceptance boundary, the instructions, when executed by the one or more processors, further cause the VST device to the one or more processors are further configured to:
classify, for the one or more contexts, the one or more camera view zones into one or more groups of camera view zones based on the correlation of the one or more contexts with the identified one or more identified targets;
determine a required number of control zones based on a count of the identified one or more identified targets; and
allocate the input acceptance boundary for one of the acceptance or the rejection of the detected user gesture based on the one or more groups of camera view zones and the required number of the control zones.

20. A non-transitory computer-readable storage medium storing instructions that, when executed by at least one processor, cause the at least one processor to:
identify one or more camera view zones based on Field of views (FOVs) of one or more cameras;
determine one or more contexts based on an analysis of each of the one or more camera view zones;
classify the one or more camera view zones for each of the determined one or more contexts; and
recognize a user gesture as an input based on the classified one or more camera view zones.
